(19) United States
(12) Patent Application Publication
(10) Pub. No.: US 2011/0156642 A1
(43) Pub. Date: Jun. 30, 2011

(54) POWER SYSTEM

(75) Inventors: Minoru NOGUCHI, Wako-shi (JP); Mitsuaki HIRAKAWA, Wako-shi (JP); Takeshi FUJINO, Wako-shi (JP); Eisuke KOMAZAWA, Wako-shi (JP)

(73) Assignee: HONDA MOTOR CO., LTD., Tokyo (JP)

(21) Appl. No.: 12/954,114

(22) Filed: Nov. 24, 2010

(30) Foreign Application Priority Data
Dec. 25, 2009 (JP) 2009-295194

(51) Int. Cl. H02J 7/02

(52) U.S. Cl. 320/109

(57) ABSTRACT

Provided is a power system capable of assisting an appropriate connection to an external power and preventing inappropriate power charge from being carried out. The power system mounted in a vehicle (1) is provided with a secondary battery (110), an electric motor (120) connected to the secondary battery (110) for driving the vehicle (1), a plurality of external power connecting members (131, 132 and 133) connected respectively by plural types of power supplying connectors for supplying electric power from an external power to the secondary battery (110), and movable insulation plates (171, 172 and 173) configured to block a further connection of a power supplying connector to the other external power connecting members when either one of the external power connecting members (131, 132 and 133) is detected by the connection detecting member to have a connection to a corresponding power supplying connector.

### BACKGROUND OF THE INVENTION

1. Field of the Invention

The present invention relates to a power system mounted in a vehicle.

2. Description of the Related Art

Conventionally, there has been known a power charge system disposed in a vehicle mounted with a power storing member for charging an external device with the power storing member in Japanese Patent Laid-open No. H9-233720. In the power charge system, the charge state of the power storing member is monitored by a controller mounted in the vehicle. When an abnormality such as a connector has been pulled out or the like happens, it is reported to a power charge device outside the vehicle (Paragraph 0011 of Japanese Patent Laid-open No. H9-233720).

However, even though it is possible for the conventional power charge system to monitor and report the charge state after the power charge is initiated, it is impossible for it to preliminarily detect problems happened prior to the power charge and to take measures to prevent the problems from happening.

Especially in present days when the power storing member and the power charge device are of various specifications, the power charge will not be carried out if the power storing member and the power charge device are not matched in specifications or a connector and a plug are not consistent; moreover, problems will happen during the power charge if the power charge is carried out in an inappropriate manner.

### SUMMARY OF THE INVENTION

The present invention has been accomplished in view of the aforementioned problems, and it is therefore an object of the present invention to provide a power system capable of assisting an appropriate connection to an external power and preventing inappropriate power charge from being carried out.

To attain an object described above according to the present invention, a first aspect of the present invention provides a power system mounted in a vehicle comprising: a power storing member; an electric motor connected to the power storing member for driving the vehicle; a plurality of external power connecting members connected respectively by plural types of power supplying connectors for supplying electric power from an external power to the power storing member; a connection detecting member configured to detect a connection of a power supplying connector to the external power connecting member; and a connection blocking member configured to block a further connection of a power supplying connector to the other external power connecting members when either one of the external power connecting members is detected by the connection detecting member to have a connection to a corresponding power supplying connector.

According to the power system of the first aspect of the present invention, when either one of the external power connecting members is connected by a power supplying connector, the connection of the power supplying connector to the other external power connecting members is blocked. According thereto, plural power supplying connectors can be prevented from being connected to the corresponding external power connecting members, avoiding the problems due to inappropriate power charge from happening during the power charge.

Thus, according to the power system of the first aspect of the present invention, an appropriate connection to an external power can be assisted and inappropriate power charge can be prevented from being carried out.

A second aspect of the present invention is dependent on the first aspect of the present invention, wherein the power supplying connector is a plug-type connector; the external power connecting member is provided with an insertion slot to be plugged in by the power supplying connector; and the connection blocking member is provided with a movable insulation plate for locking the insertion slot and an actuator for displacing the insulation plate.

According to the power system of the second aspect of the present invention, when either one of the external power connecting members is connected by a corresponding power supplying connector, the insertion slot of the external power connecting member is locked by the insulation plate; thus, the connection of the power supplying connector to the other external power connecting members can be blocked with certainty. Thereby, an appropriate connection to the external power can be assisted and inappropriate power charge can be prevented from being carried out.

A third aspect of the present invention is dependent on the first aspect of the present invention, wherein the connection detecting member detects the connection of the power supplying connector to the external power connecting member via a power line communication device.

According to the power system of the third aspect of the present invention, since the communication is configured to be available between the power supplying connector and the external power connecting member via, for example, the power line communication device, the connection therebetween can be detected easily by the power line communication device. By blocking a further connection of the power supplying connector to the other external power connecting members through the connection blocking members, an appropriate connection to the external power can be assisted and inappropriate power charge can be prevented from being carried out.

A fourth aspect of the present invention is dependent on the first aspect of the present invention is further provided with a voltage regulation member which is disposed between the external power connecting member and the power storing member for regulating a voltage of the external power and supplies the electric power of the regulated voltage to the power storing member, and a power charge controller configured to charge the power storing member by the external power, wherein the power charge controller performs the charging by controlling a voltage regulation rate of the voltage regulation member in accordance with the external power connecting member connected by the power supplying connector so as to make the voltage applied to the power storing member equal to a target voltage.

According to the power system of the fourth aspect of the present invention, when either one of the external power connecting members is connected by a corresponding power supplying connector, the connection of the power supplying connector to the other external power connecting members is blocked and the voltage of the external power connected by the power supplying connector is regulated to the target voltage via the voltage regulation member. Thereby, the power storing member can be appropriately charged at the target voltage without problems happened during the power charge.

A fifth aspect of the present invention is dependent on the first aspect of the present invention is further provided with a display member configured to display a charge state of the power storing member charged by the external power.

According to the power system of the fifth aspect of the present invention, the charge state of the power storing member charged by the external power, such as the connection state between the external power connecting member and the power supplying connector prior to the power charge, the charge state (progressing state of the power charge) of the power storing member by the external power in the power charge, or the completed charge state (energization is stopped) posterior to the power charge, is displayed by the display member. According thereto, either prior to or posterior to the power charge, whether or not appropriate power charge or an operation for the power charge is being carried out can be reported to a user; thereby, an appropriate connection to the external power can be assisted and inappropriate power charge can be prevented from being carried out.

### BRIEF DESCRIPTION OF THE DRAWINGS

FIG. 1 is an overall block diagram illustrating a vehicle mounted with a power system according to an embodiment of the present invention.

FIG. 2 is an overall block diagram illustrating the power system according to the present embodiment.

FIG. 3 is an explanatory diagram illustrating a configuration of a connection blocking member according to the present embodiment.

FIG. 4 is a flow chart illustrating a power charge process of a secondary battery.

### DETAILED DESCRIPTION OF THE PREFERRED EMBODIMENTS

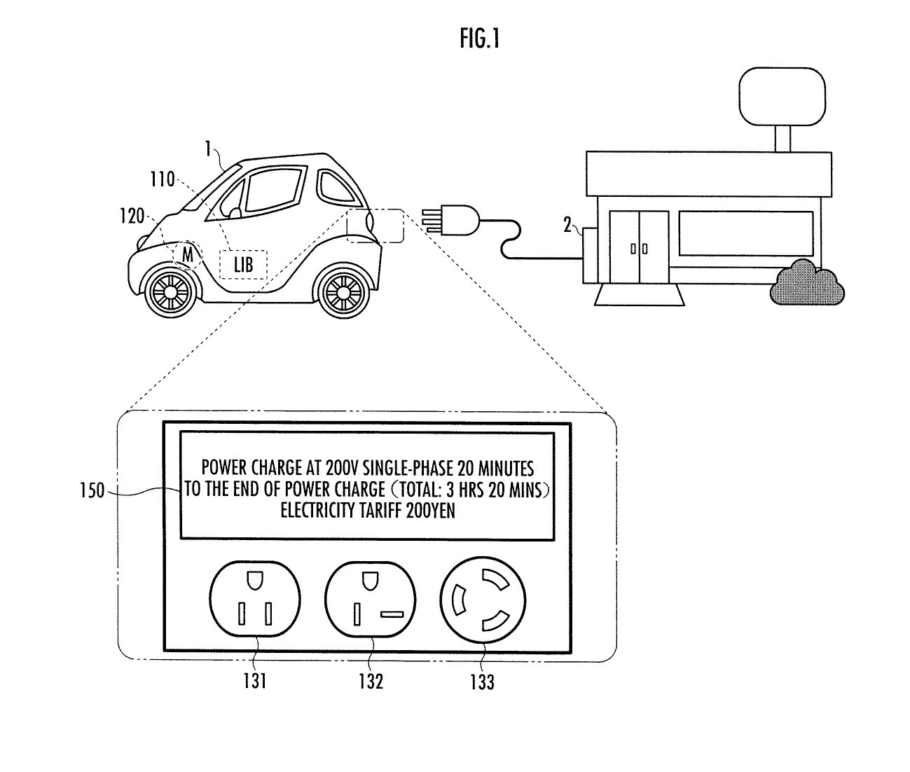

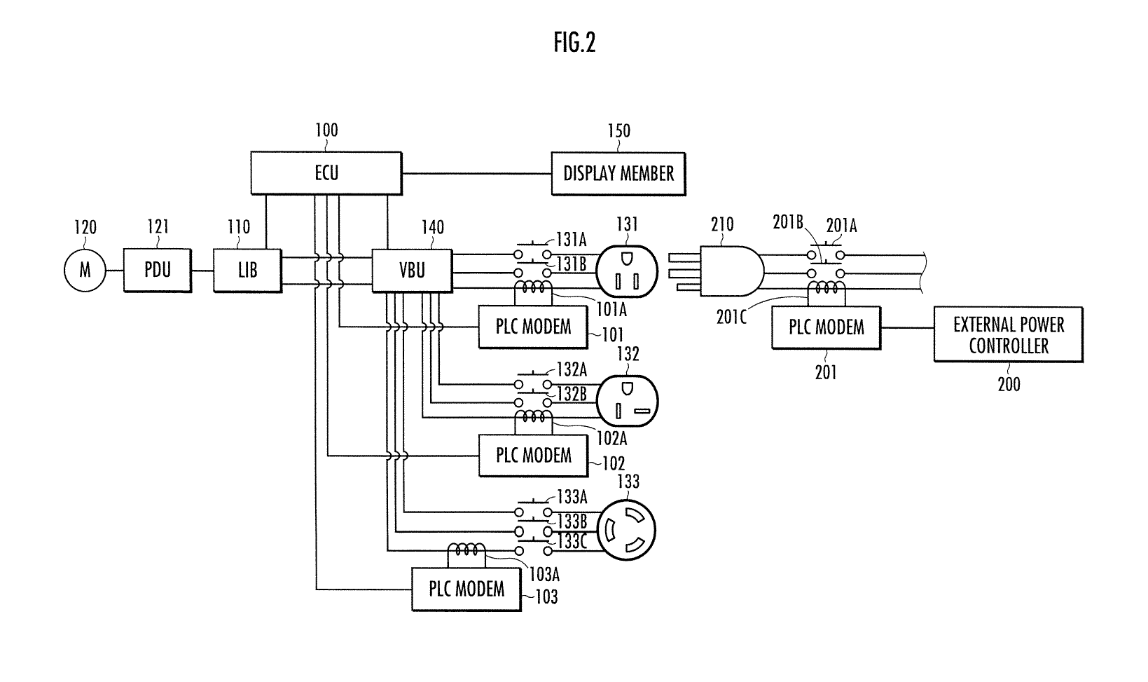

As illustrated in FIG. 1 and FIG. 2, a power system according to an embodiment of the present invention is mounted in a vehicle 1 and is provided with an electronic control unit 100, a secondary battery 110 serving as a power storing member, an electric motor 120, plural types of external power connecting members 131, 132 and 133, and a display member 150. The power system of the present invention charges the secondary battery 110 from a power charge station 2 serving as an external power disposed in a convenience store, a shopping center or the like via the external power connecting members 131, 132 and 133. The details of the electronic control unit 100 will be described hereinafter.

The secondary batter 110 may be, for example, a lithium ion battery with an output voltage varying in a range from about 300V to 500V. The secondary battery 110 is connected to the electric motor 120 via a PDU (Power Drive Unit) 121.

Further, the secondary battery 110 is connected to the first, second and third external power connecting members 131, 132 and 133 via a voltage regulation member (Voltage Boost Unit) 140.

The first external power connecting member 131 is connected by an external power of 100V (single-phase); more specifically, it is an insertion slot inserted by a power supplying connector 210 of a plug-type corresponding to the alternating-current power of 100V (single-phase). The second external power connecting member 132 is connected by an external power of 200V (single-phase); more specifically, it is an insertion slot inserted by a power supplying connector 210 of a plug-type corresponding to the alternating-current power of 200V (single-phase). The third external power connecting member 133 is connected by an external power of 200V (three-phase); more specifically, it is an insertion slot inserted by a power supplying connector 210 of a plug-type corresponding to the alternating-current power of 200V (three-phase).

The voltage regulation member 140 is an AC/DC convertor with a predefined voltage regulation rate (for example, in a range from 1.2 to 3.0), and has at least voltage increasing function. The voltage decreasing function may be added thereto if necessary. The voltage regulation member 140 performs an electric current feedback control to limit a current value after the voltage regulation equal to or smaller than a predefined current value.

A first contactor 131A and 131B is disposed between the voltage regulation member 140 and the first external power connecting member 131 for switching ON/OFF the connection therebetween. The grand line therebetween is disposed with a transmitter/receiver 101A for transmitting PLC signals output from a PLC (Power Line Communication) modem 101 serving as a power line communication device to the grand line and receiving overlapped PLC signals from the grand line.

A second contactor 132A and 132B is disposed between the voltage regulation member 140 and the second external power connecting member 132 for switching ON/OFF the connection therebetween. The grand line therebetween is disposed with a transmitter/receiver 102A for transmitting PLC signals output from a PLC modem 102 to the grand line and receiving overlapped PLC signals from the grand line.

Similarly, a third contactor 133A, 133B and 133C is disposed between the voltage regulation member 140 and the third external power connecting member 133 for switching ON/OFF the connection therebetween. The grand line therebetween is disposed with a transmitter/receiver 103A for transmitting PLC signals output from a PLC modem 103 to the grand line and receiving overlapped PLC signals from the grand line.

The electronic control unit 100 (functioning as a power charge controller of the present invention) is configured to obtain signals detected by a voltage sensor and a current sensor (not shown) disposed in the secondary battery 110, and to detect the output voltage, the output current and the output power or the like of the secondary battery 110.

Further, the electronic control unit 100 is configured to estimate the open-circuit voltage of the secondary battery 110 according to the output voltage and the output current of the secondary battery 110, and an estimate state of charge (hereinafter, referred to as SOC) of the secondary battery 110 according to a map or a data table (hereinafter, referred to as the map or the like) specifying a relationship between the estimated open-circuit voltage and the SOC of the secondary battery 110.

Furthermore, the electronic control unit 100 is configured to detect the connection of the external power to either one of the first to the third external power connecting members 131, 132 and 133 and determine the type of the connected external power via each of the PLC modems of 101 to 103 (more accurately, according to electric variation detected by the transmitter/receivers of 101A to 103A in the PLC modems, respectively). As to be described hereinafter, according to the determined type of the external power, the electronic control unit 100 displaces insulation plates 171, 172 and 173 through actuators 161, 162 and 163, respectively, to block further connection of the power supplying connector to the other external power connecting members.

In addition, the electronic control unit 100 controls ON/OFF of the first contactor 131A and 131B to the third contactors 133A, 133B and 133C, and performs operation control on the voltage regulation member 140 according to the voltage of the external power to charge the secondary battery 110 at a target voltage. Meanwhile, the electronic control unit 100 calculates the end time of power charge and the electricity tariff of power charge in consideration of the SOC of the secondary battery 110, the charge voltage and the charge current of the external power.

The power charge station 2 is provided with an external power controller 200 and a plurality of power supplying connectors (only one power supplying connector 210 is illustrated in the drawing). Through a contactor 201A and 201B which is switched ON/OFF by the external power controller 200, each power supplying connector 210 is able to be supplied with power of voltage corresponding to the shape of the connector. The grand line or the power supplying line at the side of the power supplying connector is disposed with a transmitter/receiver 201C connected to a PLC modem 201.

Thereby, when the power supplying connector 210 is connected to the external power connecting members 131 to 133, the PLC communication becomes available between the electronic control unit 100 and the external power controller 200 via the PLC modems 101 to 103 and 201.

The display member 150 may be, for example, a liquid crystal display device serving as the display device disposed in the vicinity of the external power connecting members of 131 to 133 for displaying the state of the power system. More specifically, the display member 150 displays the connection state between the external power connecting members of 131 to 133 and the power supplying connector 210, the SOC of the secondary battery 110, the charge state of the secondary battery 110 by the external power, the end time of power charge, the electricity tariff thereof and the like.

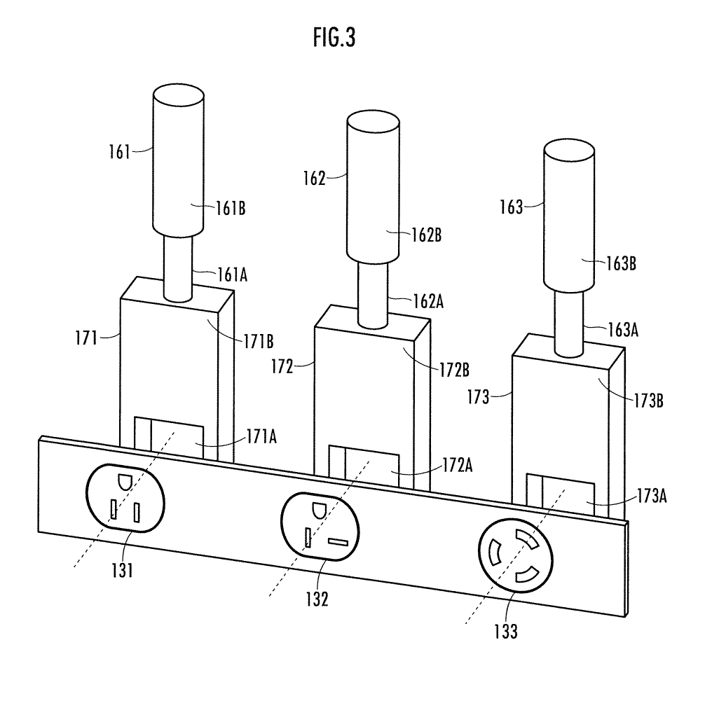

Hereinafter, with reference to FIG. 3, descriptions will be given on the control of the insulation plates 171, 172 and 173 (corresponding to the connection blocking member of the present invention) by the electronic control unit 100.

The back surfaces of the insertion slots of the first to third external power connecting members 131, 132 and 133 are disposed with the insulation plates 171, 172 and 173, respectively, for allowing or blocking the insertion of the power supplying connector 210 into the insertion slot.

The insulation plates 171, 172 and 173 are formed with open portions 171A, 172A and 173A, respectively. When the open portions 171A, 172A and 173A are positioned at the back surfaces of the insertion slots of the first to third external power connecting members 131, 132 and 133, respectively, the insertion of the power supplying connector 210 to the insertion slot is allowed; when the other portions 171B, 172B or 173B except the open portion 171A, 172A or 173A is positioned at the back surface of the insertion slot, the insertion slot is locked to block the insertion of the power supplying connector 210 impossible.

Each of the insulation plates 171, 172 and 173 is movable freely in a specific direction (the vertical direction in the present embodiment) by a guide member (not shown).

The end portions of the insulation plates 171, 172 and 173 in the movable direction are connected to movable portions 161A, 162A and 163A of actuators 161, 162 and 163 (they are linear actuators in the present embodiment), respectively. The actuators 161, 162 and 163 moves linearly the movable portions 161A, 162A and 163A with respect to actuator main bodies 161B, 162B and 163B, respectively, according to operation instructions from the electronic control unit 100. According thereto, the insulation plates 171, 172 and 173 are displaced, allowing or blocking the insertion of the power supplying connector 210 into the insertion slots of the first to third external power connecting members 131, 132 and 133, respectively.

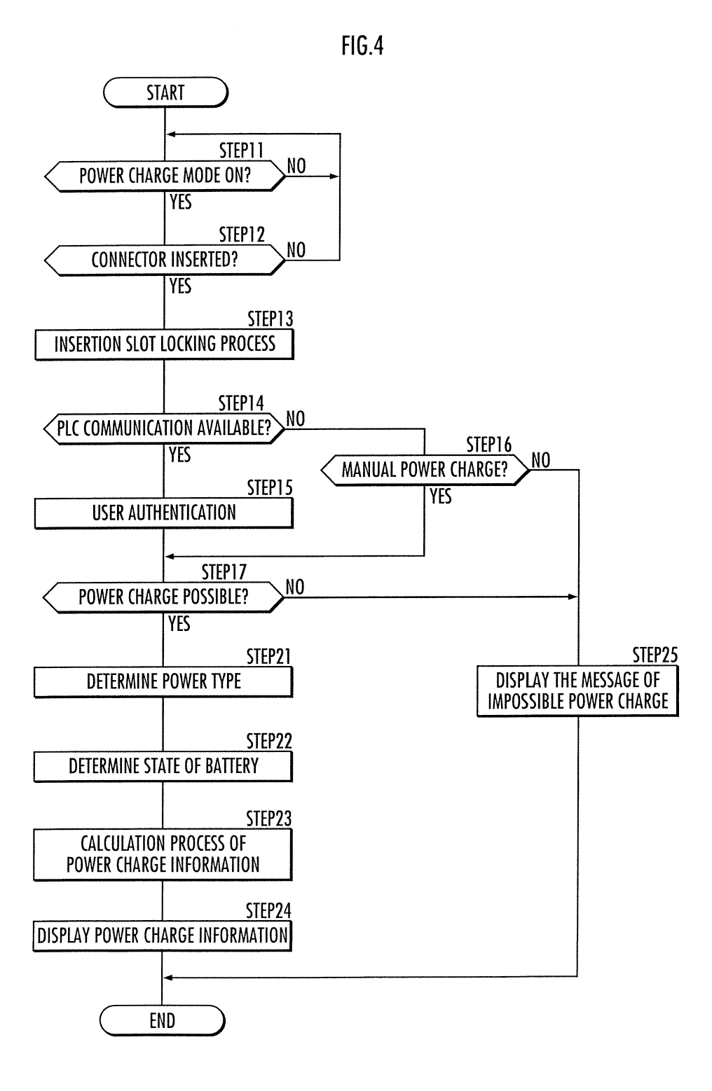

Hereinafter, with reference to the flow chart illustrated in FIG. 4, the power charge process of the secondary battery 110 will be described.

First, the electronic control unit 100 determines whether or not the power charge mode is selected by a user through an operation portion (not shown) when the vehicle is in a stopped state (FIG. 4/STEP 11).

If the power charge mode is selected (FIG. 4/YES at STEP 11), the electronic control unit 100 determines whether or not the power supplying connector 210 has been inserted into the insertion slot of the first to third external power connecting members 131, 132 and 133, respectively (FIG. 4/STEP 12).

If it is determined that the power charge mode is not selected by the user or the power supplying connected is not inserted by the electronic control unit 100 (FIG. 4 NO at STEP 11 and STEP 12), the power charge process returns to STEP 11.

On the other hand, the electronic control unit 100 determines the insertion of the power supplying connector 210 if the power supplying connector 210 is detected to have been inserted into either one of the external power connecting members 131, 132 and 133 (FIG. 4/YES at STEP 12), and subsequently, performs an insertion slot locking process to block the insertion slots of the other external power connecting members (FIG. 4/STEP 13).

In the insertion slot locking process of STEP 13, when the power supplying connector 210, for example, has been inserted into the insertion slot of the first external power connecting member 131, the electronic control unit 100 displaces the insulation plates 172 and 173 via the actuators 162 and 163 to lock the insertion slots of the second and third external power connecting members 132 and 133 except the insertion slot of the first external power connecting member 131.

According thereto, further connection of the power supplying connector to the other external power connection members 132 and 133 can be prevented with certainty; thus, the appropriate connection to the external power is assisted and inappropriate power charge can be prevented from being carried out.

Thereafter, the electronic control unit 100 determines whether or not the PLC communication by the PLC modems 101, 102 and 103 is available (FIG. 4/STEP 14).

If the communication is available between the PLC modem 201 at the side of the connected external power source, the electronic control unit 100 determines that the PLC communication is available (FIG. 4/YES at STEP 14), and performs the user authentication between the power charge station 2 by the usage of the PLC communication.

On the other hand, if the PLC communication is unavailable (FIG. 4/NO at STEP 14), for example, the power charge is performed by using a commercial household power, the electronic control unit 100 determines whether or not the manual power charge is selected (through an operation member (not shown)) by a user (FIG. 4/STEP 16).

When the manual charge is selected by the user (FIG. 4/YES at STEP 16), the user authentication of STEP 15 is omitted and whether or not the power charge is possible is determined (FIG. 4/STEP 17).

At STEP 17, the electronic control unit 100 determines that the power charge is possible when the terminal voltage, the battery temperature, the SOC and the like of the second battery 110 satisfy predefined power charge conditions (FIG. 4/YES at STEP 17).

On the other hand, if the secondary battery 110 does not satisfy the predefined power charge conditions at STEP 17 (FIG. 4/NO at STEP 17) or the manual power charge is not selected at STEP 16 (FIG. 4/NO at STEP 16), a message of impossible power charge is displayed on the display member 150 and the power charge process is terminated (FIG. 4/STEP 25).

In the process of STEP 21 subsequent to STEP 17, the electronic control unit 100 determines the type of the connected external power according to either one of the external power connecting members 131, 132 and 133 connected by the power supplying connector 210 (FIG. 4/STEP 21).

Thereafter, the electronic control unit 100 determines a target charge voltage or electric current according to the type (rated) of the secondary battery 110 and the confirmed power charge conditions of the terminal voltage, the battery temperature, the SOC and the like of the secondary battery 110 (FIG. 4/STEP 22), and performs the power charge by the external power by controlling the voltage regulation rate of the voltage regulation member 140 so as to make the charge voltage or electric current equal to the target charge voltage or electric current.

In the power charge, the electronic control unit 100 initiates the power charge by switching ON the 133A, 133B and 133C (if the PLC communication is possible, the electronic control unit 100 performs the communication between the external power controller 200 via the PLC modem 201, and switches on the connectors 201A and 201B at the side of the power supplying connector 201 in the meantime).

The electronic control unit 100 calculates the end time of power charge, the electricity tariff or the like for the power charge according to the SOC and the target charge voltage or electric current of the secondary battery 110 (FIG. 4/STEP 23), and displays them on the display member 150 as illustrated in FIG. 1, for example (FIG. 4/STEP 24).

The details of the charge process of the secondary battery 110 according to the present embodiment are described in the above. According to the charge process, the appropriate connection to an external power is assisted by the insulation plates 171, 172 and 173, and inappropriate power charge can be prevented from being carried out.

In the present embodiment, it is acceptable that the electric motor 120 functions as a generator when the vehicle is decelerating, and the regenerative power generated by the electric motor 120 in the deceleration of the vehicle is recovered to charge the secondary battery 110. Herein, the electronic control unit 100 detects the regenerative power generated by the electric motor 120 according to a voltage sensor and an electric current sensor (not shown) provided in the PDU 121 and performs operation control on a velocity reducer or a voltage controller (not shown) to charge the secondary battery 110 by using the regenerative power generated by the electric motor 120.

In the present embodiment, the insulation plates 171, 172 and 173 are configured to be locked after the power supplying connector is inserted in the open state (FIG. 4/STEP 13), in addition thereto, it is acceptable to vary the state of the insulation plates 171, 172 and 173 appropriately according to the state of the vehicle. For example, all the insulation plates 171, 172 and 173 may be configured to be in the locked state when the vehicle is running; when the vehicle is stopped or according to the selection of power charge mode, all the insulation plates 171, 172 and 173 are configured to be opened from the locked state. After the end of power charge, all the insulation plates 171, 172 and 173 may be configured to be set in the locked state to prevent further power charge.

Furthermore, in the present embodiment, the connection blocking member is configured to block the insertion of the power supplying connector 210 through the insulation plates 171, 172 and 173; however, it is not limited thereto. The first to the third connectors, the contactors 201A and 201B at the side of the power charge station 2 may be used as the connection blocking member.

We claim:

1. A power system mounted in a vehicle, comprising:
a power storing member;
an electric motor connected to the power storing member for driving the vehicle;
a plurality of external power connecting members connected respectively by plural types of power supplying connectors for supplying electric power to the power storing member from an external power;
a connection detecting member configured to detect a connection of a power supplying connector to the external power connecting member; and
a connection blocking member configured to block a further connection of a power supplying connector to the other external power connecting members when either one of the external power connecting members is detected by the connection detecting member to have a connection to a corresponding power supplying connector.

2. The power system according to claim 1, wherein
the power supplying connector is a plug-type connector;
the external power connecting member is provided with an insertion slot to be plugged in by the power supplying connector; and
the connection blocking member is provided with a movable insulation plate for locking the insertion slot and an actuator for displacing the insulation plate.

3. The power system according to claim 1, wherein the connection detecting member detects the connection of the power supplying connector to the external power connecting member via a power line communication device.

4. The power system according to claim 1 is further provided with
a voltage regulation member which is disposed between the external power connecting member and the power storing member for regulating a voltage of the external power and supplies the electric power of the regulated voltage to the power storing member, and
a power charge controller configured to charge the power storing member by the external power,
wherein the power charge controller performs the charging by controlling a voltage regulation rate of the voltage regulation member in accordance with the external power connecting member connected by the power supplying connector so as to make the voltage applied to the power storing member equal to a target voltage.

5. The power system according to claim 1 is further provided with a display member configured to display a charge state of the power storing member charged by the external power.
